(19) United States
(12) Patent Application Publication
(10) Pub. No.: US 2009/0122259 A1
(43) Pub. Date: May 14, 2009

(54) Eyeglass holder

(76) Inventor: Deborah J. Szumski, Deerfield Beach, FL (US)

Correspondence Address: Robert M. Downey, P.A.;Ste. 300, 6751 N. Federal Hwy., Boca Ration, FL, 33487, US

(21) Appl. No.: 11/983,669

(22) Filed: Nov. 9, 2007

(51) Int. Cl. G02C 11/00; B65D 25/22

(52) U.S. Cl. 351/158; 220/483

(57) ABSTRACT

A device for holding eyeglasses includes a receptacle defined by a front wall and a flat rear wall extending upwardly from a bottom to an open top. The receptacle is sized and configured to receive a pair of eyeglasses through the open top. When placed in the receptacle, the eyeglasses rest on the bottom and are contained by the front and rear walls. A magnet on the rear wall allows the device to be removably mounted on a metal surface such as a refrigerator door.

### BACKGROUND OF THE INVENTION

1. Field of the Invention

This invention relates to holders for eyeglasses, pens, pencils, markers and the like and, more particularly to a cup like receptacle with a flat rear wall having a magnet for mounting the receptacle to a metal surface such as a refrigerator door.

2. Discussion of the Related Art

Eventually, most people find it difficult to read printed text without the aid of a magnifying glass or reading glasses. Often, the need for such reading aids arises in the kitchen. For instance, those who love to cook may notice problems with their eyesight when attempting to read the relatively small print in cookbooks and on recipe cards. Others needing reading glasses may simply enjoy reading a book or magazine at the kitchen counter or table. Not surprisingly, eyeglasses are often misplaced or lost in the kitchen, especially when a person is constantly removing their reading glasses that are only needed when the person is trying to read small print. This may happen when a person is cooking and wears reading glasses only when trying to read the ingredients and instructions in a recipe. Accordingly, there remains a definite need for a readily accessible device for holding eyeglasses (e.g., reading glasses) that allows a person to repeatedly wear and remove their eyeglasses without misplacing them, and particularly in the kitchen.

### OBJECTS OF THE INVENTION

Considering the foregoing, it is a primary object of the present invention to provide a simple holder device that allows a person to easily remove and replace their reading glasses without misplacing them.

It is a further object of the present invention to provide a simple holder device for eyeglasses (e.g., reading glasses) that is particularly useful in the kitchen.

It is still a further object of the present invention to provide a simple and efficient holder device for eyeglasses (e.g., reading glasses), pens, pencils, markers, scissors and other articles, and wherein the holder device removably mounts to a refrigerator door with the use of one or more magnets.

### SUMMARY OF THE INVENTION

The present invention is directed to a device for holding eyeglasses, and particularly reading glasses. The device includes a receptacle defined by a front wall and a flat rear wall extending upwardly from a bottom to an open top. The receptacle is sized and configured to receive a pair of eyeglasses through the open top, with the temple arms of the eyeglasses folded closed. When placed in the receptacle, the eyeglasses rest on the bottom and are contained by the front and rear walls. A magnet on the rear wall allows the device to be removably mounted on a metal surface such as a refrigerator door.

### BRIEF DESCRIPTION OF THE DRAWINGS

For a fuller understanding of the nature of the present invention, reference should be made to the following detailed description taken in conjunction with the accompanying drawings in which:

FIG. 1 is a top front perspective view of the eyeglass holder device of the present invention;

FIG. 2 is a top rear perspective view of the eyeglass holder device; and

FIG. 3 is a perspective view showing the eyeglass holder device mounted to a refrigerator door, with the use of a magnet, and holding a pair of eyeglasses.

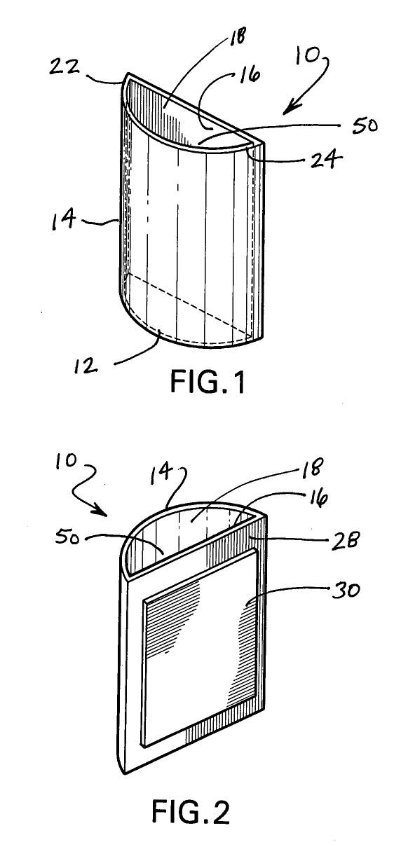

Like reference numerals refer to like parts throughout the several views of the drawings.

### DETAILED DESCRIPTION OF THE PREFERRED EMBODIMENT

Referring to the several views in the drawings, the eyeglass holder device is shown according to a preferred embodiment and is generally indicated as 10. The eyeglass holder device 10 is preferably formed as an integral, one-piece unit and includes a bottom wall 12 and front 14 and rear 16 walls extending upwardly from the bottom wall to an open top 18. In the preferred embodiment, the front wall 14 has an arcuate shape with a smooth uninterrupted curvature from the left side 22 to the right side 24 where the front wall 14 joins the rear wall 16. The bottom wall 12 is shaped to conform with the curvature of the front wall 14. This provides a low profile, aesthetic appearance to the device.

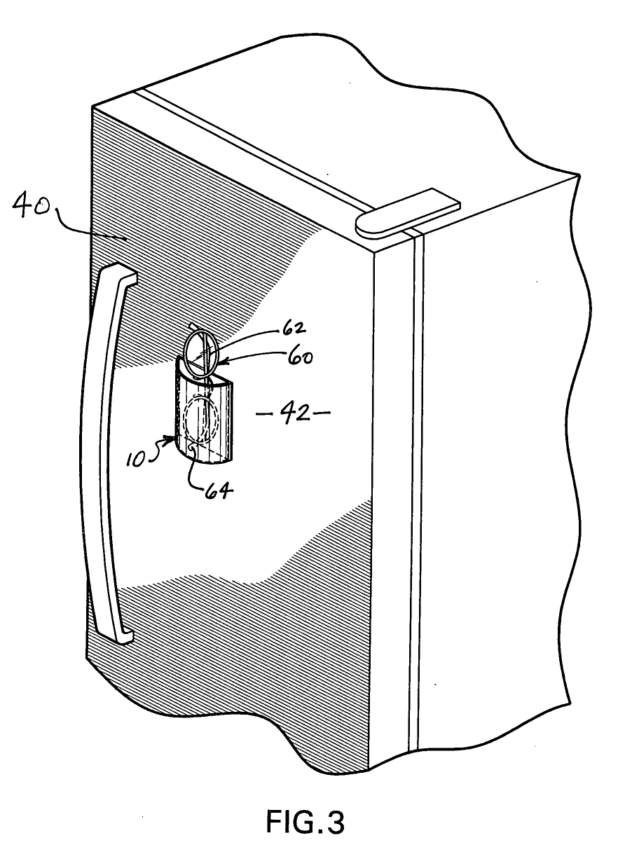

The rear wall 16 is flat and includes an outer flat surface 28 for mounting the eyeglass holder device 10 to a mounting surface 42. Specifically, the outer facing flat side 28 of the rear wall 16 is provided with at least one magnet 30 for removably mounting the eyeglass holder device 10 to a magnetically attractive surface 42, such as a refrigerator door 40, as seen in FIG. 3. In order to enhance the overall appearance, the eyeglass holder device 10 may be formed of an acrylic, or other plastic resin material, in a color that matches the color of the refrigerator door 40. This, combined with the low profile shape, allows the eyeglass holder device 10 to blend with the refrigerator door 40, or other mounting surface 42.

The open top 18 communicates with an interior chamber 50 that is surrounded by the bottom 12, front 14 and rear 16 walls. The open top 18 and interior chamber 50 are sized and configured for receiving a pair of eyeglasses 60 therein, with the temple arms 62,64 of the eyeglasses 60 folded closed, as seen in FIG. 3. When placed therein, the eyeglasses 60 rest on the bottom wall 12 and are contained by the surrounding bottom, front end rear walls, yet easily accessible through the open top 18 for removal and replacement within the holder device 10.

It is noted that other articles, such as pens, pencils, scissors, and the like, can be placed within the interior chamber 50 of the holder device 10.

While the present invention has been shown and described in accordance with a preferred and practical embodiment thereof, it is recognized that departures from the instant disclosure are fully contemplated within the spirit and scope of the invention which is limited only by following claims as interpreted under the Doctrine of Equivalents.

What is claimed is:

1. A holder device comprising:
a bottom wall, a front wall, a flat rear wall including a flat outer surface, said front wall and said flat rear wall extending upwardly from said bottom wall to an open top communicating with an interior chamber surrounded by said front wall and said flat rear wall, and said open top and said interior chamber being sized and configured for receiving a pair of folded eyeglasses therein; and
at least one magnet on said flat outer surface of said flat rear wall for removably mounting the device on a magnetically attractive mounting surface.

2. The holder device as recited in claim 1 wherein said front wall has an arcuate shape providing a smooth curvature from a left side to a right side of said front wall.

3. The holder device as recited in claim 2 wherein said front wall is opaque.

4. The holder device as recited in claim 3 wherein said front wall is of the same color as the mounting surface.

5. The holder device as recited in claim 4 wherein said bottom wall, said front wall and said rear wall are of the same color as the mounting surface.

6. The holder device as recited in claim 1 wherein said open top is widest between the transverse center of said front wall and the transverse center of said rear wall.

7. An eyeglass holder assembly comprising:
a pair of eyeglasses having left and right temple arms movable between an open, operable position and a folded, collapsed position;
a bottom wall, a front wall, a flat rear wall including a flat outer surface, said front wall and said flat rear wall extending upwardly from said bottom wall to an open top communicating with an interior chamber surrounded by said front wall and said flat rear wall, and said open top and said interior chamber being sized and configured for receiving said pair of eyeglasses within said interior chamber with said left and right temple arms in said folded, collapsed position; and
at least one magnet on said flat outer surface of said flat rear wall for removably mounting the device on a magnetically attractive mounting surface.

8. The eyeglass holder assembly as recited in claim 7 wherein said front wall has an arcuate shape providing a smooth curvature from a left side to a right side of said front wall.

9. The eyeglass holder assembly as recited in claim 8 wherein said front wall is opaque.

10. The eyeglass holder assembly as recited in claim 9 wherein said front wall is of the same color as the mounting surface.

11. The eyeglass holder assembly as recited in claim 10 wherein said bottom wall, said front wall and said rear wall are of the same color as the mounting surface.

12. The eyeglass holder assembly as recited in claim 7 wherein said open top is widest between the transverse center of said front wall and the transverse center of said rear wall.
